(19) United States
(12) Patent Application Publication
(10) Pub. No.: US 2002/0042922 A1
(43) Pub. Date: Apr. 11, 2002

(54) Video box of VOD system

(75) Inventors: Ta-Chun Wang, Taipei Hsien (TW); Wen-Jen Ho, Hualien (TW)

Correspondence Address: DARBY & DARBY P.C., 805 Third Avenue, New York, NY, 10022, US

(73) Assignee: Institute For Information Industry

(21) Appl. No.: 09/771,783

(22) Filed: Jan. 29, 2001

(30) Foreign Application Priority Data
Oct. 11, 2000 (TW) 89121222

(51) Int. Cl. H04N 7/173

(52) U.S. Cl. 725/92; 725/91; 725/103

(57) ABSTRACT

A video box of VOD system, comprising: A first signal processor, receiving an input signal that comprises analog program signals, wherein the first signal processor transfers the analog program signals into digital program signals, and compressing the digital program signals into compressed program signals according to a compressing format, wherein the input signal is transmitted via a cable TV system; A storage device, storing the compressed program signals; A selecting device, which is adapted to provide a selecting signal, whereby selecting a decompressing signal from the compressed program signals in the storage device; and a second signal processor, decompressing the decompressing signal into a broadcasting signal according to a decompressing format, and transmitting the broadcasting signals to a media device, thereby broadcasting the broadcasting signals.

### BACKGROUND OF THE INVENTION

1. Field of the Invention

The present invention relates to a video box of VOD (video on demand) system, and particularly relates to a video box that is adapted to a CATV (Cable TV)-based VOD system.

2. Description of the Prior Art

A VOD (Video on Demand) system is a client-oriented video system, in which users can actively choose any video program. A typical VOD system consists of three major components: client, server, and network (not shown). Firstly, at the client end, basically, there should be a TV set or a computer in order to issue some control signals and receive the selected video program. Secondly, the VOD server has a large amount of data in a database, which can store lots of video programs. Finally, the network is used mainly to transfer video programs from servers to clients.

A familiar example of VOD system companies is the ISP (Internet Service Provider) corporations.

The VOD systems provide the benefit that a client has more options in selecting video programs. For media corporations, moreover, video programs that are serially broadcasted are substituted by that of passively downloaded video programs, according to the selections of clients. Therefore, a VOD system could effectively provides a cost reduction for the corporations.

However, because of the limitations produced from the bandwidth of data transmission, existing VOD systems have disadvantages in popularization. On the other hand, for a VOD system, some basic functions, such as Play, Stop, Fast Forward, and Fast Backward, are required. These functions demand additional hardware such as memory, and increase additional costs. Moreover, the time delay and additional burden of the network system are resultant problems as well.

### SUMMARY OF THE INVENTION

Accordingly, the present invention provides a video box of a VOD system, comprising a first signal processor, receiving an input signal that comprises analog program signals, wherein the first signal processor transfers the analog program signals into digital program signals, and compressing the digital program signals into compressed program signals according to a compressing format, wherein the input signal is transmitted via a cable TV system; a storage device, storing the compressed program signals; a selecting device, which is adapted to provide a selecting signal, whereby selecting a decompressing signal from the compressed program signals in the storage device; and a second signal processor, decompressing the decompressing signal into a broadcasting signal according to a decompressing format, and transmitting the broadcasting signals to a media device, thereby broadcasting the broadcasting signals.

The first signal processor further comprises a control unit, which is provided to send out a first control signal, wherein the storage device and the second signal receive the first control signal; The storage device starts storing the compressed program signals as receiving the first control signal; and the second signal processor idles as it receives the control signal.

The input signal further comprises a transmission signal, and the control unit produces the first control signal as the first signal processor detects the transmission signal.

The storage device comprises a disk device, wherein the disk device stores the compressing program signals with existing data of the disk device, which is overwritten.

The compressing format includes an encryption rule, and the decompressing format includes a decryption rule corresponding to the encryption rule.

The media device may be a digital TV or an analog TV. In the case for an analog TV, the second signal processor further comprises a D/A converter, which is provided to convert the broadcasting signals into the analog TV.

The input signal further comprises a stop-transmission signal, whereby the control device essentially stops sending out the first control signal as the first signal processor receives the stop-transmission signal. That is, the VOD system stops program-input as the stop-transmission signal is received. Another substitute method is that the VOD system further comprises a timer device, which is used to clock a transmission time, and the input signal further comprises a transmission-time signal, which indicates a predetermined time; and the timer device starts clocking the transmission time as the control device starts sending out the first control signal, and the control device stops sending out the first control signal as the transmission time reaches the predetermined time.

### BRIEF DESCRIPTION OF THE DRAWINGS

The present invention can be fully understood from the following detailed description and preferred embodiment with reference to the accompanying drawings in which:

FIG. 1 is a schematic graph showing the structure of an embodiment of the VOD system according to the present invention.

FIG. 2 is a flow chart of an embodiment of the VOD system according to the present invention, showing the switching between a data-receiving state and a broadcasting state.

### DETAILED DESCRIPTION OF THE EMBODIMENT

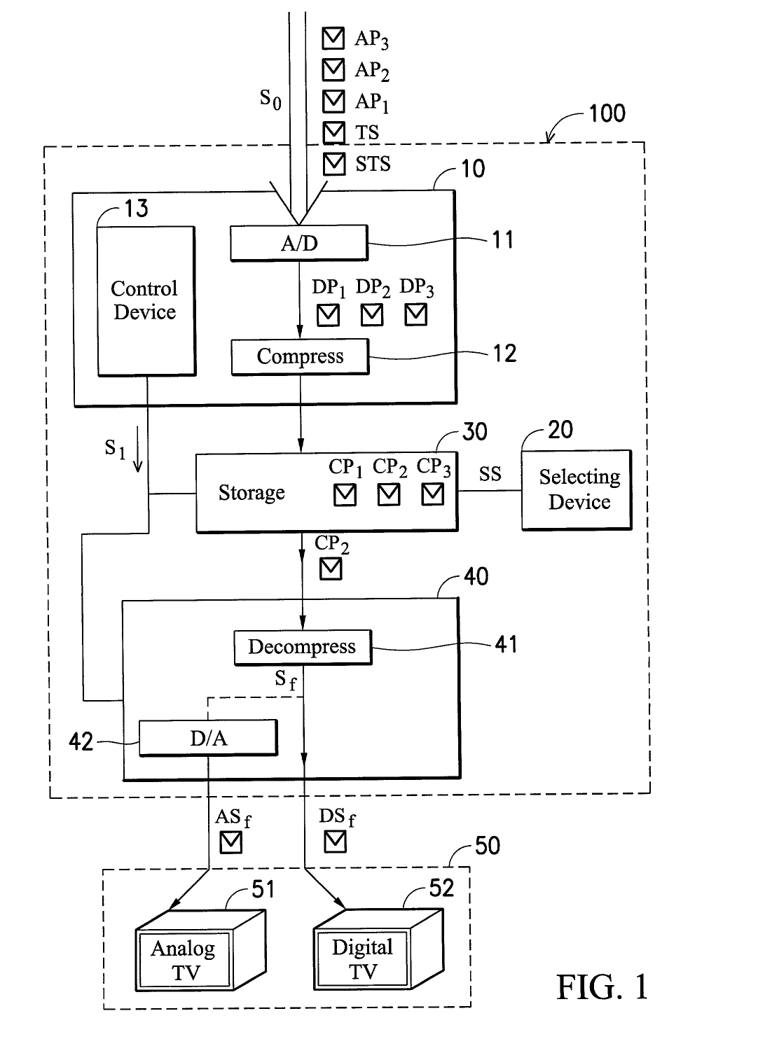

FIG. 1 is a schematic graph showing the structure of an embodiment of the video box 100 according to the present invention. In the Fig.ure, an input signal of cable TV, which is indicated by s0, comprises a plurality of program signals (indicated by AP1, AP2, and AP3) and a transmission signal TS. The transmission formats of the program signals are preferably typical formats of an existing cable TV system.

The VOD system comprises a first signal processor 10, which receives the input signal s0 and transfers the analog program signals AP1, AP2, and AP3 into digital program signals DP1, DP2, and DP3 in an A/D converting device 11. Afterward, the digital program signals DP1, DP2, and DP3 are compressed into compressed program signals CP1, CP2, and CP3 in the first signal processor 10. The compression is operated according to a compressing format 12, which may be existing formats, such as MPEG II, MPEG IV, and so on.

There is a storage device 30 in the video box 100, which is provided to store the compressed program signals CP1, CP2, and CP3.

The VOD system further comprises a selecting device 30, which is adapted to provide a selecting signal SS, whereby selecting a decompressing signal from the compressed program signals CP1, CP2, and CP3 in the storage device, for example, CP2 shown in FIG. 1.

A second signal processor 40 is provided to decompress the decompressing signal CP2 selected above into a broadcasting signal Sf according to a decompressing format 41, and transmits the broadcasting signals Sf to a media device 50, thereby broadcasting the broadcasting signals Sf.

The first signal processor 10 further comprises a control unit 13, which is provided to send out a first control signal CS1 as detecting the transmission signal TS in the input signal S0, wherein the first control signal CS1 is received by the storage device 30 and the second signal processor 40. The storage device 30 starts storing the compressed program signals CP1, CP2, and CP3 as receiving the first control signal CS1, and the second signal processor 40 idles (disabled) as receiving the first control signal CS1.

The storage device 30 comprises a disk device, wherein the disk device stores the compressing program signals CP1, CP2, and CP3. It is preferable that the program signals CP1˜CP3 are stored with existing data (previously stored program data) of the disk device that is overwritten, whereby the cable TV corporations may renew their program menus according to program schedules.

In order to prevent pirating, preferably, the compressing format 12 mentioned above includes an encryption rule (not shown), and the decompressing format includes a decryption rule (not shown) corresponding to the encryption rule.

The media device may be a digital TV or an analog TV. The broadcasting signal transmitted to the digital TV is indicated with DSf (digital broadcasting signal). In the case of using analog TV, the second signal processor 40 further comprises a D/A converter 42, which is provided to convert the broadcasting signals Sf into analog signals ASf. Accordingly, It is preferable that the video box 100 comprises two output ports, which are provided for digital TVs and analog TVs, respectively.

As shown in FIG. 1, preferably, the input signal S0 further comprises a stop-transmission signal STS, whereby the control device 13 essentially stops sending out the first control signal CS1 as the first signal processor 10 receives the stop-transmission signal STS. This is a method to switch the video box 100 from a data-receiving state to a broadcasting-state, wherein the second signal processor 40 is enabled, and users could select the program with the selecting device 20.

For the switching process mentioned above, another method is further providing a timer device (not shown) in the VOD system, wherein the timer device is used to clock a transmission time. Correspondingly, the input signal is provided with a transmission-time signal, which indicates a predetermined time that is required by the data transmission operation. The timer device starts clocking the transmission time as the control device 13 starts sending out the first control signal CS1, and the control device stops 13 sending out the first control signal CS1 as the clocked transmission time reaches the predetermined time.

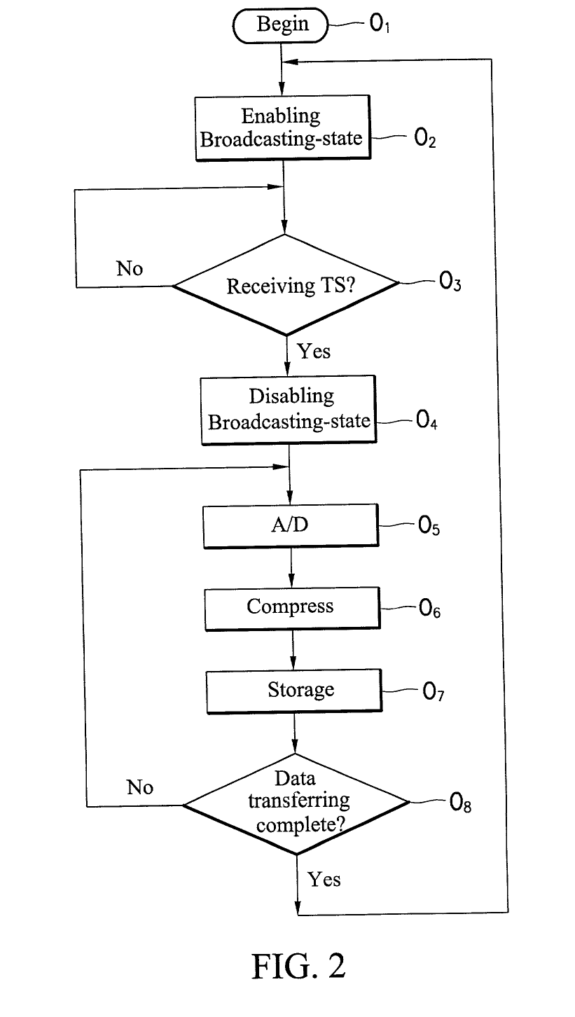

Refer to the flow chart shown in FIG. 2. In the beginning, the video box 100 enables the broadcasting state. As shown by O3, the broadcasting state remains as long as the transmission signal TS is not detected. In this state, users could select and watch the program data stored in the video box 100.

Operations O4˜O8 in FIG. 2 are the data transmission process of the video box 100. As detecting the transmission signal TS, the video box 100 begins to run the data-receiving operation mentioned above. After the operation is complete, the video box 100 is switched back to the broadcasting-state.

Though the video box 100 has the storage device 30, by simply varying the data-reading format provided to read the contents stored in the storage device 30, the video box 100 has some easily performed, basic functions, such as Play, Stop, Fast Forward, Fast Backward, etc. Moreover, the selecting device 20 preferably comprises icons that relate to these functions (not shown).

While the invention has been described with reference to a preferred embodiment, the description is not intended to be construed in a limiting sense. It is therefore contemplated that the appended claims will cover any such modifications or embodiments as may fall within the scope of the invention defined by the following claims and their equivalents.

What is claimed is:

1. A video box of a VOD system, comprising:
A first signal processor, receiving an input signal that comprises analog program signals, wherein the first signal processor transfers the analog program signals into digital program signals, and then compresses the digital program signals into compressed program signals according to a compressing format, wherein the input signal is transmitted via a cable TV system;
A storage device, storing the compressed program signals;
A selecting device, which is adapted to provide a selecting signal, whereby selecting a decompressing signal from the compressed program signals in the storage device; and
A second signal processor, decompressing the decompressing signal into a broadcasting signal according to a decompressing format, and transmitting the broadcasting signals to a media device, thereby broadcasting the broadcasting signals.

2. The video box of claim 1, wherein the first signal processor further comprises a control unit, which is provided to send out a first control signal, wherein the first control signal is received by the storage device and the second signal processor;
The storage device starts storing the compressed program signals as receiving the first control signal; and
The second signal processor idles as receiving the first control signal.

3. The video box of claim 2, wherein the input signal further comprises a transmission signal, and the control unit produces the first control signal as the first signal processor detects the transmission signal.

4. The video box of claim 3, wherein the storage device comprises a disk device.

5. The video box of claim 4, wherein the disk device stores the compressing program signals with existing data of the disk device that is overwritten.

6. The video box of claim 4, wherein the compressing format includes an encryption rule, and the decompressing format includes a decryption rule corresponding to the encryption rule.

7. The video box of claim 4, wherein the media device is a digital TV.

8. The video box of claim 4, wherein the second signal processor further comprises a D/A converter, which is provided to convert the broadcasting signals into analog signals, and the media device is an analog TV.

9. The video box of claim 4, wherein the input signal further comprises a stop-transmission signal, whereby the control device essentially stops sending out the first control signal as the first signal processor receives the stop-transmission signal.

10. The video box of claim 4, further comprising a timer device, which is used to clock a transmission time;
The input signal further comprises a transmission-time signal, which indicates a predetermined time; and
The timer device starts clocking the transmission time as the control device starts sending out the first control signal, and the control device stops sending out the first control signal as the transmission time reaches the predetermined time.
